(19) United States
(12) Patent Application Publication
(10) Pub. No.: US 2026/0235868 A1
(43) Pub. Date: Aug. 13, 2026

(54) HEAD-UP DISPLAY DEVICE

(71) Applicant: Nippon Seiki Co., Ltd., Niigata (JP)

(72) Inventors: Yohei Sato, Niigata (JP); Wataru Saito, Niigata (JP); Yoshiki Matsumoto, Niigata (JP); Yutaka Fujita, Niigata (JP)

(21) Appl. No.: 19/156,972

(22) PCT Filed: Mar. 14, 2024
(86) PCT No.: PCT/JP2024/009915

§ 371 Date: Aug. 15, 2025

(30) Foreign Application Priority Data
Mar. 15, 2023 (JP) 2023-040405

(51) Int. Cl. G02B 27/01; B60K 35/234

(52) U.S. Cl. CPC G02B 27/0101; B60K 35/234; B60K 2360/33; G02B 2027/0118

(57) ABSTRACT

Provided is a head-up display device that can increase the uniformity of a virtual image. The head-up display device comprises: a light source 11a that emits illumination light IL; a second lens 14 that transmits the illumination light IL from the light source 11a; a display panel 12 that is provided in a direction forming a non-right angle with respect to a travel direction of the illumination light IL from the second lens 14, receives the illumination light IL, and radiates display light L; and a diffusion plate 15 that is disposed in nonparallel to the display panel 12, diffuses the illumination light IL from the second lens 14, and emits the diffused illumination light IL toward the display panel 12.

### TECHNICAL FIELD

The present disclosure relates to a head-up display device.

### BACKGROUND ART

A head-up display device described in Patent Document 1 displays a virtual image by emitting display light representing an image toward a windshield of a vehicle. Such a head-up display device includes a backlight unit that emits illumination light, and a display unit that receives the illumination light from the backlight unit to emit display light. The display unit includes a display panel that receives the illumination light to emit the display light, and a diffusion plate that is located on a rear surface of the display panel and that diffuses the illumination light.

### PRIOR ART DOCUMENT

### Patent Document

Patent Document 1: WO 2022/045064 A

### SUMMARY OF THE INVENTION

### Problems to be Solved by the Invention

In a configuration described in above Patent Document 1, by tilting an orientation of the display panel relative to a direction perpendicular to a travel direction of the illumination light, a difference is created in an optical path length of the display light in an up-down direction, and an orientation of a virtual image can be brought closer in parallel to a road surface. However, a uniformity of the virtual image may decrease due to the difference in the optical path length of the display light.

The present disclosure has been made in consideration of the above-described circumstances, and an object thereof is to provide a head-up display device capable of improving the uniformity of a virtual image.

### Solution to Problem

In order to achieve the above-mentioned object, a head-up display device according to the present disclosure includes a light source that emits illumination light, a lens through which the illumination light from the light source passes, a display that is provided in an orientation forming a non-right angle relative to a travel direction of the illumination light from the lens, the display that receives the illumination light to emit display light, and a diffusion plate that is placed nonparallel to the display, the diffusion plate that diffuses the illumination light from the lens and emits the diffused illumination light towards the display.

### Effect of the Invention

According to the present disclosure, it is possible to improve a uniformity of a virtual image.

### BRIEF DESCRIPTION OF THE DRAWINGS

FIG. 1 is a schematic diagram of a head-up display device according to a first embodiment of the present disclosure.

FIG. 2 is a schematic cross-sectional view of a display unit according to the first embodiment of the present disclosure.

FIG. 3 is a schematic cross-sectional view of a display unit according to a comparative example.

FIG. 4 is a schematic cross-sectional view of a display unit according to a second embodiment of the present disclosure.

FIG. 5 is a schematic cross-sectional view of a display unit according to a comparative example and a modification of the present disclosure.

FIG. 6 is a perspective view of a second lens according to the second embodiment of the present disclosure.

FIG. 7 is an enlarged view of a region E in FIG. 6.

FIG. 8 is a perspective view of the display unit according to the second embodiment of the present disclosure.

FIG. 9 is a perspective view of the display unit in a state where a light source substrate and a first lens are removed according to the second embodiment of the present disclosure.

FIG. 10 is a schematic cross-sectional view of the display unit according to a modification of the present disclosure.

FIG. 11 is a schematic cross-sectional view of the display unit according to the modification of the present disclosure.

### MODE FOR CARRYING OUT THE INVENTION

### First Embodiment

A head-up display device according to a first embodiment of the present disclosure will be described with reference to the drawings.

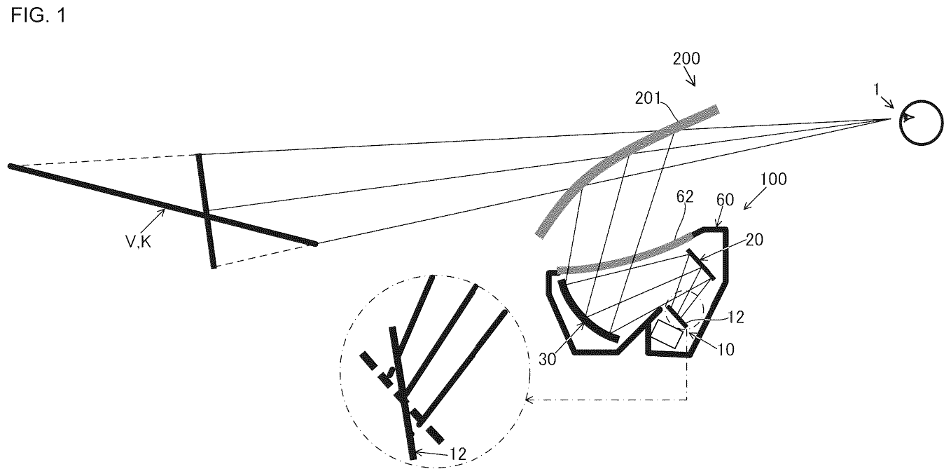

As illustrated in FIG. 1, a head-up display device 100 is installed in a dashboard of a vehicle 200. The head-up display device 100 emits display light L representing an image toward a windshield 201 that is a front glass of the vehicle 200. The display light L is reflected by the windshield 201 to reach a viewer 1 (mainly, a driver of the vehicle 200). As a result, a virtual image V is displayed on a virtual image display surface K parallel to a road surface.

The head-up display device 100 includes a display unit 10, a folding mirror 20, a concave mirror 30, and a housing 60.

The housing 60 is formed of a non-light-transmitting resin or a metal and has a hollow, substantially rectangular parallelepiped shape. The housing 60 is formed with an opening at a position facing the windshield 201. The housing 60 includes a window portion 62 that closes the opening. The window portion 62 is formed of a light-transmitting resin such as acrylic, through which the display light L passes. The housing 60 houses the display unit 10, the concave mirror 30, and the folding mirror 20.

The folding mirror 20 and the concave mirror 30 configure an optical relay guiding the display light L from the display unit 10 to the windshield 201. The folding mirror 20 reflects the display light L from the display unit 10 toward the concave mirror 30. The folding mirror 20 is a plane mirror. It is noted that the folding mirror 20 is not limited to a plane mirror, but may be a concave mirror.

The concave mirror 30 reflects the display light L from the display unit 10 toward the windshield 201 while magnifying the display light L.

Next, a specific configuration of the display unit 10 will be described.

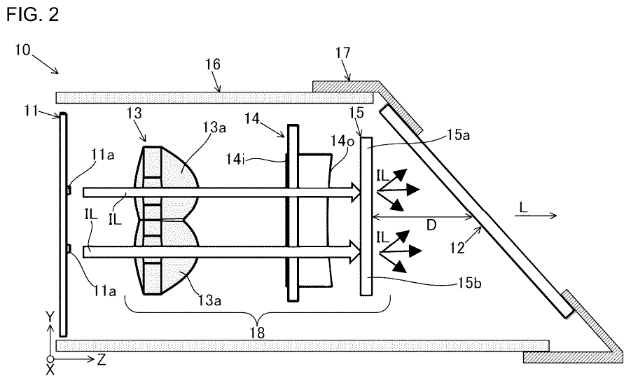

As illustrated in FIG. 2, the display unit 10 includes a light source substrate 11 including a plurality of light sources 11a, a display panel 12, an illumination optical system 18, a lens holder 16, and a display panel holder 17.

The illumination optical system 18 adjusts the illumination light IL from each of the plurality of light sources 11a. The adjustment of the illumination light IL refers to collimating the illumination light IL, diffusing, scattering, or converging the illumination light IL. The illumination optical system 18 includes a first lens 13, a second lens 14, and a diffusion plate 15.

In the following description, the travel direction of the illumination light IL emitted from the light source 11a is defined as a Z direction, a height direction of a vehicle is defined as a Y direction, and a width direction of the vehicle is defined as an X direction. In the present example, the X direction is a longitudinal direction of each of the lenses 13 and 14, and the Y direction is a transverse direction of each of the lenses 13 and 14.

The first lens 13, the second lens 14, and the diffusion plate 15 are arranged in the Z direction to be parallel to each other. The lens holder 16 has a rectangular cylindrical shape surrounding a periphery of the first lens 13, the second lens 14, and the diffusion plate 15, and holds the first lens 13, the second lens 14, and the diffusion plate 15 within an internal space of the lens holder 16.

The plurality of light sources 11a are mounted on a surface facing the first lens 13 of the light source substrate 11.

The first lens 13 is a condenser lens, and is formed of a light-transmitting resin or glass in a plate shape. The first lens 13 has a function of approximately collimating each light beam of the illumination light IL emitted from each light source 11a in the Z direction.

The first lens 13 includes a plurality of convex lens units 13a arranged in the X direction and the Y direction. Each of the convex lens units 13a is formed in a biconvex lens shape. The plurality of convex lens units 13a are placed in a matrix in one-to-one correspondence with the plurality of light sources 11a respectively.

The second lens 14 is a light distribution lens expanding the illumination light IL approximately collimated by the first lens 13, to fit a display area of the display panel 12, and is formed of a light-transmitting resin or glass into a plate shape. The second lens 14 includes a light incident surface 14i on which light is incident, and a light emission surface 14o from which light passing through the second lens 14 in a thickness direction thereof emits. The light incident surface 14i is formed with a cylindrical lens array extending in the Y direction and being aligned in the X direction. The light emission surface 14o is formed with a toroidal surface having different curvatures in the X and Y directions.

To suppress occurrence of unevenness in light intensity, the diffusion plate 15 diffuses the illumination light IL from the second lens 14 and radiates such light towards the display panel 12. The diffusion plate 15 faces the light emission surface 14o of the second lens 14.

The display panel 12 is a thin film transistor (TFT) type liquid crystal display panel. The display panel 12 receives the illumination light IL passing through the diffusion plate 15 to emit the display light L under the control of a control unit (not illustrated). The display panel 12 is oriented to form a non-right angle relative to the travel direction of the illumination light IL and nonparallel to the diffusion plate 15.

The diffusion plate 15 includes a first portion 15a optically corresponding to the upper portion of the virtual image display surface K as seen by a viewer, and a second portion 15b optically corresponding to the lower portion of the virtual image display surface K as seen by the viewer. An orientation of the display panel 12 is set so that a distance D in the Z direction between the first portion 15a of the diffusion plate 15 and the display panel 12 is smaller than the distance D in the Z direction between the second portion 15b of the diffusion plate 15 and the display panel 12. Depending on the orientation of the display panel 12, a distance from the display panel 12 to a reflective surface of the folding mirror 20 varies in a surface direction of the display panel 12, and thus, there is a difference in the optical path length from the display panel 12 to an upper end and a lower end of the virtual image display surface K. As a result, as viewed by the viewer 1, the lower end of the virtual image display surface K leans toward a near side and the upper end of the virtual image display surface K leans toward a far side. As a result, it is possible to make the virtual image display surface K parallel to a road surface.

The display panel holder 17 is attached to the lens holder 16 in a state in which the display panel 12 is held to surround an outer periphery of the display panel 12.

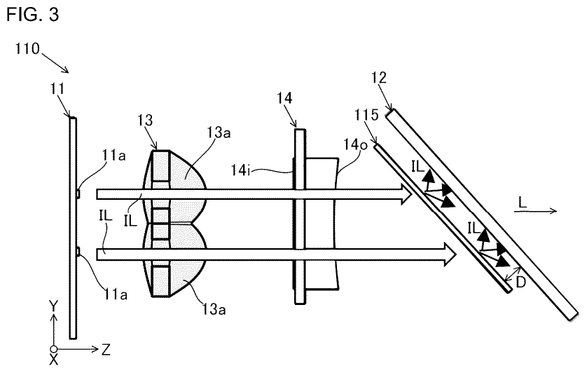

Next, a display unit 110 according to a comparative example illustrated in FIG. 3 will be described.

A diffusion plate 115 of the display unit 110 is provided to be parallel to the display panel 12. The distance D between the diffusion plate 115 and the display panel 12 is constant. In such a case, due to the difference in the optical path length described above, a virtual image luminance of an upper half area of the virtual image display surface K is higher than a virtual image luminance of a lower half area of the virtual image display surface K. Therefore, a uniformity of the virtual image V is low.

In such a regard, in the display unit 10 according to the present embodiment, the distance D between the second portion 15b of the diffusion plate 15 and the display panel 12 is greater than the distance D between the first portion 15a of the diffusion plate 15 and the display panel 12. An average distance D between the diffusion plate 15 and the display panel 12 is larger than the distance D between the diffusion plate 115 and the display panel 12 according to the comparative example. As the distance D increases, a degree of diffusion of the illumination light IL increases, and this contributes to a dispersion of a luminance bias. Therefore, the virtual images in the lower half area and the upper half area of the virtual image display surface K are uniformed, and the uniformity of the virtual image V is improved.

### Effects

Thus, according to the first embodiment described above, the following effects are achieved.

(1) The head-up display device 100 for displaying the virtual image V includes the light source 11a that emits the illumination light IL, the second lens 14, which is an example of a lens through which the illumination light IL from the light source 11a passes, the display panel 12, which is an example of a display that is provided in an orientation forming a non-right angle relative to a travel direction of the illumination light IL from the second lens 14, the display that receives the illumination light IL to emit display light L, and the diffusion plate 15 that is placed nonparallel to the display panel 12, the diffusion plate 15 that diffuses the illumination light IL from the second lens 14 and emits the diffused illumination light IL towards the display panel 12.

According to such a configuration, the diffusion plate 15 is placed nonparallel to the display panel 12. Therefore, the distance D between the diffusion plate 15 and the display panel 12 can be adjusted according to a position of the display panel 12 in the surface direction, and as a result, it is possible to adjust the degree of diffusion of the illumination light IL in the surface direction of the display panel 12 until the illumination light IL reaches the display panel 12. The degree of diffusion of the illumination light IL affects a luminance of the virtual image V, and thus, it is possible to improve the uniformity of the virtual image V.

(2) The diffusion plate 15 is placed parallel to the light source substrate 11 mounted thereon with the light source 11a.

According to such a configuration, there is no need to place the diffusion plate 15 in a different orientation from the light source substrate 11, and thus, the configuration is unlikely to be complicated.

(3) The head-up display device 100 is mounted on the vehicle 200, and projects the display light L from the display panel 12 onto the windshield 201 to display the virtual image V on the virtual image display surface K parallel to the road surface. The diffusion plate 15 includes the first portion 15a optically corresponding to the upper portion of the virtual image display surface K as seen by the viewer, and the second portion 15b optically corresponding to the lower portion of the virtual image display surface K as seen by a viewer. The diffusion plate 15 is placed in such an orientation that the distance D between the first portion 15a and the display panel 12 is shorter than the distance D between the second portion 15b and the display panel 12.

With such a configuration, the orientation of the diffusion plate 15 relative to the display panel 12 prevents the virtual image luminance in the upper half area of the virtual image display surface K from being higher than the virtual image luminance in the lower half area of the virtual image display surface K. Therefore, it is possible to improve the uniformity of the virtual image V.

### Second Embodiment

A head-up display device according to a second embodiment of the present disclosure will be described with reference to the drawings. The following description will focus on differences from the first embodiment.

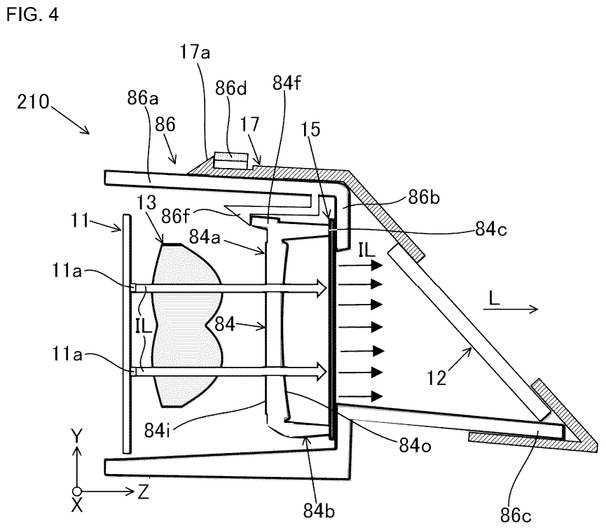

As illustrated in FIGS. 4, 8, and 9, a lens holder 86 of a display unit 210 according to the present embodiment includes a cylindrical portion 86a, a holder frame portion 86b, a panel support portion 86c, and a plurality of lens locking hook portions 86f. The lens holder 86 is formed of a light-shielding resin.

The cylindrical portion 86a has a rectangular cylindrical shape surrounding a periphery of each of the light source substrate 11, the first lens 13, the second lens 14, and the diffusion plate 15.

The holder frame portion 86b is located at an end of the cylindrical portion 86a on a display panel 12 side, and is formed in a rectangular frame plate shape extending toward an inner periphery of the cylindrical portion 86a. The holder frame portion 86b includes an opening hole which opens toward the display panel 12 and through which the illumination light transmitted through the diffusion plate 15 passes. An inner surface of the holder frame portion 86b (surface on a light source substrate 11 side) is in contact with an outer periphery of the diffusion plate 15.

The panel support portion 86c is located on an outer surface (surface on the display panel 12 side) of the holder frame portion 86b, and has a rectangular cylindrical shape with an inclined tip portion. The tip portion of the panel support portion 86c supports the display panel 12 in an orientation forming a non-right angle relative to the Z direction.

The plurality of lens locking hook portions 86f lock a second lens 84 to press the second lens 84 against the holder frame portion 86b. The plurality of lens locking hook portions 86f (two in the present example) are located inside the cylindrical portion 86a, extend toward the light source substrate 11 side, and are formed to be elastically deformable in the Y direction. A tip portion of each of the lens locking hook portions 86f is hooked onto a below-described hook receiving portion 84f of the second lens 84.

The second lens 84 includes a lens main body portion 84a, a lens frame portion 84b, and the hook receiving portion 84f. The lens main body portion 84a includes a light incident surface 84i formed thereon with a cylindrical lens array, and a light emission surface 84o formed thereon with a toroidal surface. The lens frame portion 84b is formed integrally with the lens main body portion 84a around the lens main body portion 84a. The lens frame portion 84b is formed as a side wall surrounding the light emission surface 84o. The lens frame portion 84b includes a diffusion plate holding surface 84c which is an end surface on a travel direction side of the illumination light IL.

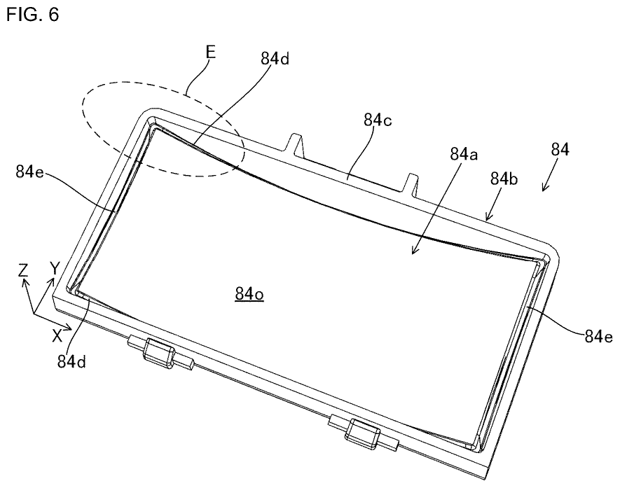

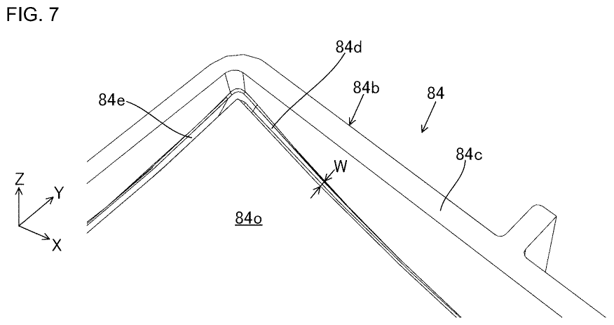

As illustrated in FIGS. 6 and 7, the second lens 84 includes grooves 84d and 84e. The grooves 84d and 84e are formed in a U-shaped groove shape relative to the light emission surface 84o over the entire area between the lens frame portion 84b and the light emission surface 84o. The grooves 84d and 84e are formed for retaining dust.

Two of the grooves 84d are parallel to each other and extend in the X direction.

Two of the grooves 84e are parallel to each other and extend in the Y direction in a manner to connect both ends of the two grooves 84d.

A groove width W of each groove 84d is formed to increase in size from a center toward an outside of the light emission surface 84o in the X direction. In other words, the groove width W of each groove 84d is narrowed near the center of the light emission surface 84o. The groove width of the groove 84e is constant.

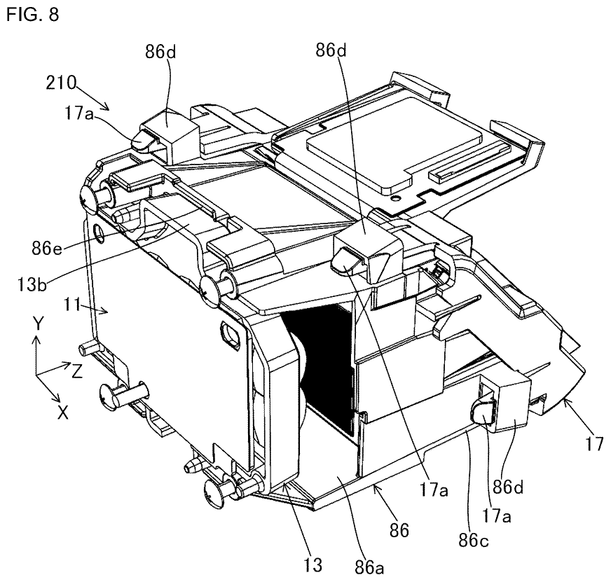

As illustrated in FIG. 8, the display panel holder 17 includes a plurality of holder locking hook portions 17a that lock onto the lens holder 86. The lens holder 86 includes a plurality of fitting portions 86d into which each of the holder locking hook portions 17a fits. Each of the plurality of fitting portions 86d includes a hole which passes through in the Z direction and through which the holder locking hook portion 17a can be inserted. While the holder locking hook portion 17a is inserted through such a hole, a tip portion of the holder locking hook portion 17a is hooked onto the fitting portion 86d.

The first lens 13 includes a holding portion 13b formed on an outer periphery of the first lens 13. The lens holder 86 includes a housing portion 86e that houses the holding portion 13b. While being housed in the housing portion 86e, the holding portion 13b is held between the housing portion 86e and a heat sink (not illustrated).

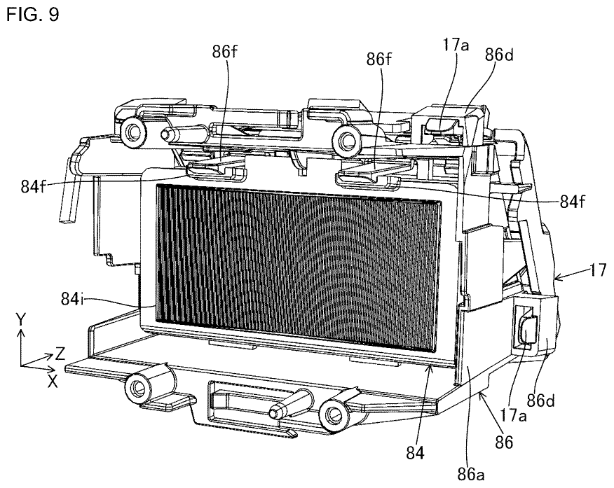

As illustrated in FIG. 9, the second lens 84 includes a plurality of the hook receiving portions 84f. The plurality of hook receiving portions 84f are located on an outer periphery side of the light incident surface 84i of the lens main body portion 84a. The plurality of hook receiving portions 84f (two in the present example) are arranged in the X direction above the light incident surface 84i of the lens main body portion 84a. Each hook receiving portion 84f has a convex shape facing the light source substrate 11.

### Effects

Thus, according to the second embodiment described above, the following effects are achieved.

(1) The head-up display device 100 includes the lens holder 86 which is an example of a holder that houses the second lens 84. The lens holder 86 includes the holder frame portion 86b including an opening through which the illumination light IL traveling toward the display panel 12 passes. An outer peripheral portion of the diffusion plate 15 is placed to face a surface close to the light source 11a of the holder frame portion 86b.

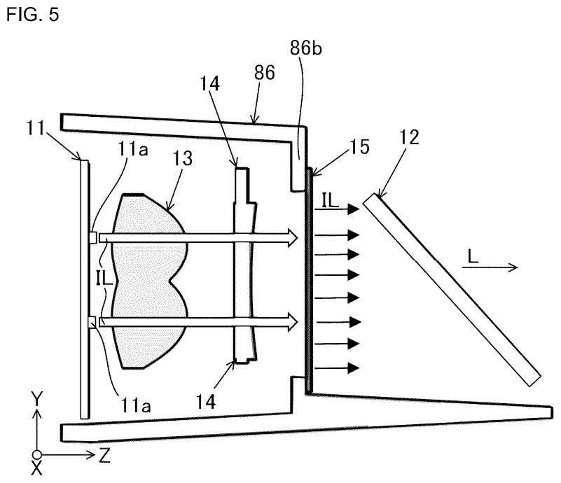

As a comparative example, as illustrated in FIG. 5, if the diffusion plate 15 is installed on a surface of the holder frame portion 86b at a side closer to the display panel 12, the illumination light is irradiated towards the display panel 12 also from an outer peripheral edge of the diffusion plate 15, and an end on an inner peripheral side of the holder frame portion 86b located at a back side of such an outer peripheral portion is reflected as a shadow in the virtual image V, and as a result, a display quality of the virtual image V may be deteriorated. In such a regard, in the above-described configuration, the diffusion plate 15 is placed to face the surface close to the light source 11a of the holder frame portion 86b. In such a case, the outer peripheral portion of the diffusion plate 15 is hidden by the holder frame portion 86b, and the illumination light traveling from the outer peripheral portion of the diffusion plate 15 toward the display panel 12 is blocked by the holder frame portion 86b. This prevents the end on the inner peripheral side of the holder frame portion 86b from appearing as the shadow in the virtual image V. Therefore, it is possible to improve the display quality of the virtual image V.

It is possible to house the diffusion plate 15 within the lens holder 86, and thus, there is no need to provide a space in which the diffusion plate 15 is housed outside the lens holder 86. Therefore, it is possible to simplify a structure of the lens holder 86.

(2) The second lens 84 includes the lens main body portion 84a through which the illumination light IL from the light source 11a passes, and the lens frame portion 84b formed to surround a periphery of the lens main body portion 84a, the lens frame portion 84b holding the diffusion plate 15 in the holder frame portion 86b by pressing an outer peripheral portion of the diffusion plate 15 toward the holder frame portion 86b.

According to such a configuration, a separate configuration for holding the diffusion plate 15 in the holder frame portion 86b is not required, and the configuration is simplified. Moreover, an assembly of the head-up display device 100 is simplified.

(3) The second lens 84 includes the grooves 84d and 84e formed in a concave shape between the light emission surface 84o of the lens main body portion 84a and the lens frame portion 84b.

According to such a configuration, it is possible to retain, in the grooves 84d and 84e, the dust generated when the head-up display device 100 is assembled or when the head-up display device 100 is vibrated. This prevents the dust from adhering to the light emission surface 84o, and it is possible to maintain the display quality of the virtual image V.

(4) The groove width W of the groove 84d is formed to increase with increasing distance from the center of the light emission surface 84o.

According to such a configuration, the adhesion of the dust near the center of the light emission surface 84o is suppressed, and it is possible to maintain the display quality of the central portion where the virtual image V is most likely to be visible.

It is noted that the present disclosure is not limited to the above-described embodiments and drawings. Appropriate modifications (including a deletion of components) may be made without departing from the spirit of the present disclosure. An example of the modification will be described below.

### Modification

In the above second embodiment, the lens frame portion 84b is formed integrally with the lens main body portion 84a, but may be formed separately from the lens main body portion 84a. In such a case, the lens body portion 84a, which is a separate body, has a rectangular cylindrical shape capable of housing the lens body portion 84a therein.

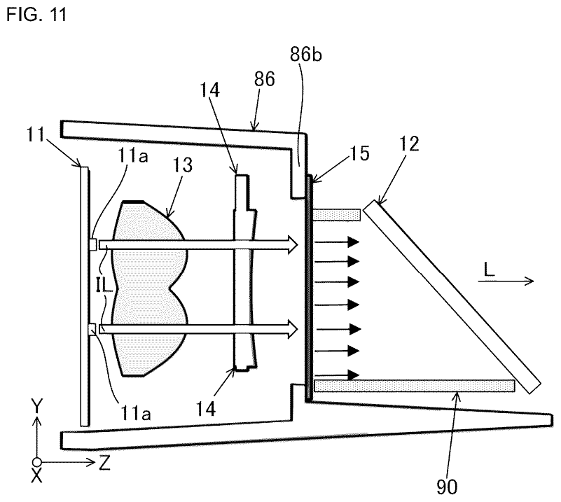

In the above second embodiment, the diffusion plate 15 is placed to be in contact with the surface close to the light source 11a of the holder frame portion 86b, but in addition thereto, and the diffusion plate 15 may be installed on a surface of the holder frame portion 86b at a side closer to the display panel 12, as illustrated in FIG. 11. In such a case, a cylindrical member 90 having an internal space through which the illumination light IL passes may be provided between the holder frame portion 86b and the display panel 12. The cylindrical member 90 prevents the end on the inner peripheral side of the holder frame portion 86b from appearing as the shadow in the virtual image V. Therefore, it is possible to improve the display quality of the virtual image V. As illustrated in FIG. 5, the diffusion plate 15 may be fixed to the surface of the holder frame portion 86b at a side closer to the display panel 12 by using a light-blocking double-sided tape or adhesive, and thus, the shadow may be prevented from appearing in the virtual image V.

In the above second embodiment, the groove width W of the groove 84d is formed to gradually increase in size from the center toward the outside of the light emission surface 84o in the X direction, but in addition thereto, the groove width W may be formed to increase in size stepwise from the center toward the outside in the X direction of the light emission surface 84o. The groove 84d at a center portion of the light emission surface 84o in the X direction may be omitted.

In the above second embodiment, the groove width of the groove 84e is formed to be constant, but the groove width may be formed to increase gradually or stepwise from the center of the light emission surface 84o in the Y direction toward the outside.

At least one of the grooves 84d and 84e may be omitted.

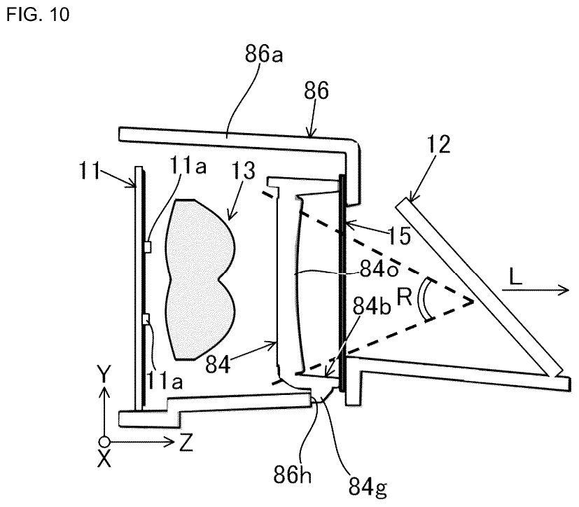

In the above second embodiment, the second lens 84 is held in the lens holder 86 by the lens locking hook portions 86f of the lens holder 86, but the lens locking hook portions 86f may be omitted. In such a case, as illustrated in FIG. 10, the second lens 84 may include a locking portion 84g that locks onto the lens holder 86. The locking portion 84g is formed in a convex shape on the outer peripheral surface of the lens frame portion 84b. The cylindrical portion 86a of the lens holder 86 is formed with a locking hole 86h into which the locking portion 84g fits. The locking portion 84g is provided at a position close to the display panel 12 relative to the light emission surface 84o. This allows the locking portion 84g to be placed outside a visible region R, and prevents the locking portion 84g, the locking hole 86h, and the like from appearing in the virtual image V.

In each of the above embodiments, the folding mirror 20 may be omitted.

In each of the above embodiments, the illumination optical system 18 includes the two lenses 13 and 14, but the number of lenses may be one or three or more. A type and a shape of the lenses included in the illumination optical system 18 may be changed as appropriate.

In each of the above embodiments, the virtual image display surface K may or may not be parallel to the road surface.

In each of the above embodiments, the head-up display device 100 is mounted on the vehicle 200, but the head-up display device 100 may be mounted on a conveyance other than the vehicle 200.

### DESCRIPTION OF REFERENCE NUMERALS

1 Viewer
10, 110, 210 Display unit
11 Light source substrate
11a Light source
12 Display panel
13 First lens
13a Convex lens unit
13b Holding portion
14 Second lens
14i, 84i Light incidence surface
14o, 84o Light emitting surface
15, 115 Diffusion plate
15a First portion
15b Second portion
16 Lens holder
17 Display panel holder
17a Holder locking hook portion
18 Illumination optical system
20 Folding mirror
30 Concave mirror
60 Housing
62 Window portion
84 Second lens
84a Lens main body portion
84b Lens frame portion
84c Diffuser plate holding surface
84d, 84e Groove
84f Hook receiving portion
84g Locking portion
86 Lens holder
86a Cylindrical portion
86b Holder frame portion
86c Panel support portion
86d Fitting portion
86e Housing portion
86f Lens locking hook portion
86h Locking hole
90 Cylindrical member
100 Head-up display device
200 Vehicle
201 Windshield
D Distance
K Virtual image display surface
L Display light
R Visible region
V Virtual image
W Groove width
IL Illumination light

1. A head-up display device comprising:
a light source that emits illumination light;
a lens through which the illumination light from the light source passes;
a display that is provided in an orientation forming a non-right angle relative to a travel direction of the illumination light from the lens, the display receiving the illumination light to emit display light; and
a diffusion plate that is placed nonparallel to the display, the diffusion plate diffusing the illumination light from the lens and emitting the diffused illumination light towards the display.

2. The head-up display device according to claim 1, wherein the diffusion plate is placed parallel to a substrate on which the light source is mounted.

3. The head-up display device according to claim 1, wherein the head-up display device is mounted on a vehicle and displays a virtual image on a display surface along a road surface by projecting display light from the display onto a windshield,
the diffusion plate includes:
a first portion optically corresponding to an upper portion of the display surface as viewed by a viewer; and
a second portion optically corresponding to a lower portion of the display surface as viewed by the viewer, and
the diffusion plate is placed in an orientation such that the first portion is closer to the display than the second portion is.

4. The head-up display device according to claim 1, wherein the head-up display device includes a holder that houses the lens,
the holder includes a holder frame portion including an opening through which the illumination light toward the display passes, and
an outer peripheral portion of the diffusion plate is placed to approach or contact a surface closer to the light source of the holder frame portion.

5. The head-up display device according to claim 4, wherein the lens includes:
a lens main body portion through which the illumination light from the light source passes; and
a lens frame portion formed to surround a periphery of the lens main body portion, the lens frame portion holding the diffusion plate in the holder frame portion by pressing an outer peripheral portion of the diffusion plate toward the holder frame portion.

6. The head-up display device according to claim 5, wherein the lens includes a groove formed in a concave shape between a light emission surface of the lens main body portion and the lens frame portion.

7. The head-up display device according to claim 6, wherein a groove width of the groove is formed to increase with increasing distance from a center of the light emission surface.
